(19) United States
(12) Patent Application Publication
(10) Pub. No.: US 2007/0139696 A1
(43) Pub. Date: Jun. 21, 2007

(54) Method and apparatus for printing document with related document

(75) Inventor: Seung-Yul Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/493,581

(22) Filed: Jul. 27, 2006

(30) Foreign Application Priority Data
Dec. 16, 2005 (KR) 2005-124850

(51) Int. Cl. G06F 3/12

(52) U.S. Cl. 358/1.15; 358/403

(57) ABSTRACT

A method and system to print a document with a related document are provided. A frequently used document can be stored in a printer as a related document. A document and searching information on the document is transmitted to the printer. The related document of the document is searched among the documents stored in the printer by using the searching information, and displayed. At least one of the displayed related documents is selected by a user and printed together with the document. This results in greater convenience to the user because the user does not need to individually find a corresponding related document for printing.

### CROSS-REFERENCE TO RELATED APPLICATIONS

This application claims the benefit under 35 U.S.C. §119(a) of Korean Patent Application No. 2005-124850, filed Dec. 16, 2005, in the Korean Intellectual Property Office, the entire disclosure of which is hereby incorporated by reference.

### BACKGROUND OF THE INVENTION

1. Field of the Invention

The present invention relates to a method and apparatus for printing a document with a related document. More particularly, the present invention relates to a method for printing a document with a related document, using a host and a printer, in which a related document of documents stored in the printer is searched, the searched related document is displayed, selected by a user, and printed with a document.

2. Description of the Related Art

In many situations, it may be customary for a user to print one document along with a standard related document. For example, a user who prints a specific document may need to print additional standard letters or forms along with that specific document. Documents frequently used in a company such as official company document forms are often printed together with newly created documents. The user may experience an inconvenience if there is a need to individually search a related document so that it can ultimately be printed. If the related document is not stored in a host of the user, the corresponding document should be duplicated or downloaded from other apparatuses for printing.

Accordingly, there is a need for an improved system and method for printing a document with a related document by using a host and a printer.

### SUMMARY OF THE INVENTION

An aspect of an exemplary embodiment of the present invention is to address at least the above problems and/or disadvantages and to provide at least the advantages described below. Accordingly, an aspect of exemplary embodiments of the present invention is to provide a method for printing a document with a related document using a host and a printer. The printer stores a frequently used document as a related document. The related document of the document is then searched among the documents stored in the printer and displayed. A user selects at least one of the displayed related documents so that the related document can be printed together with the document.

In order to achieve the above-described aspects of an exemplary embodiment of the present invention, a method for printing is provided. The document and searching information on the document are transmitted to a printer. The transmitted searching information is used to search a related document of the documents stored in the printer. The document is then printed together with the related document.

The document stored in the printer is stored together with index information including a name, a writer, a writing time, a storing time or a keyword of the document stored in the printer; and an explanation on the document stored in the printer. The operation of searching compares the searching information and the index information.

The searching information is the name, the writer, the writing time, the storing time or the keyword of the document.

The operation of transmitting includes the searching information in a PJL (printer job language).

The operation of transmitting is input with the searching information through a UI (user interface) provided by a printer driver or an application.

A list of the searched related documents is displayed and at least one of the searched related documents is selected from the list of the displayed related documents.

The printer or a host controlling the printer displays and selects the related documents.

In order to achieve the above-described aspects of an exemplary embodiment of the present invention, a printer receives a document, searches information on the document, and performs a printing operation. The printer comprises a storing unit, a printing unit, and a controlling unit. The storing unit stores a document and the printing unit performs the printing operation. The controlling unit controls a related document of the document to be searched among the stored documents by using the searching information so that the document and the related document may be printed by the printing unit.

The searching information includes a name, a writer, a writing time, a storing time or a keyword of the document.

The storing unit stores index information including the name, the writer, the writing time, the storing time or the keyword of the stored document; and an explanation on the stored document. The controlling unit compares the searching information and the index information, and searches the related document.

The printer further comprises a displaying unit and an inputting unit. The displaying unit displays a list of the searched related documents. The inputting unit facilitates the selection of at least one related document from the list of displayed related documents. The controlling unit controls the printing unit to print the document and the selected related document.

The controlling unit controls the list of the searched related documents to be transmitted to the host and the control unit controls at least one related document selected by a user from the list of the related documents to be received by the host so that the selected related document and the document are printed by the printing unit.

In order to achieve the above-described aspects of exemplary embodiments of the present invention, a host is provided. A displaying unit displays a list of related documents of a document. An inputting unit facilitates the selection of at least one related document from the displayed list of the related documents. A controlling unit controls the document and searching information on the document to be transmitted to a printer, the list of the searched related documents to be received by the printer and displayed by the displaying unit, and the selected related document to be transmitted to the printer.

The searching information includes a name, a writer, a writing time, a storing time or a keyword of the document.

The searching information is included in a PJL (printer job language) and transmitted.

The inputting unit is input with the searching information.

The inputting unit is a UI (user interface) provided with a printer driver or an application.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above aspect and other objects, features and advantages of certain exemplary embodiments of the present invention will be more apparent from the following description taken in conjunction with the accompanying drawings, in which:

FIG. 1 is a functional block diagram illustrating a structure of a printing system including a host and a printer according to an exemplary embodiment of the present invention;

FIG. 2 is a flowchart explaining a printing method according to the exemplary embodiment of the present invention; and

FIGS. 3 and 4 illustrate a user interface according to the exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

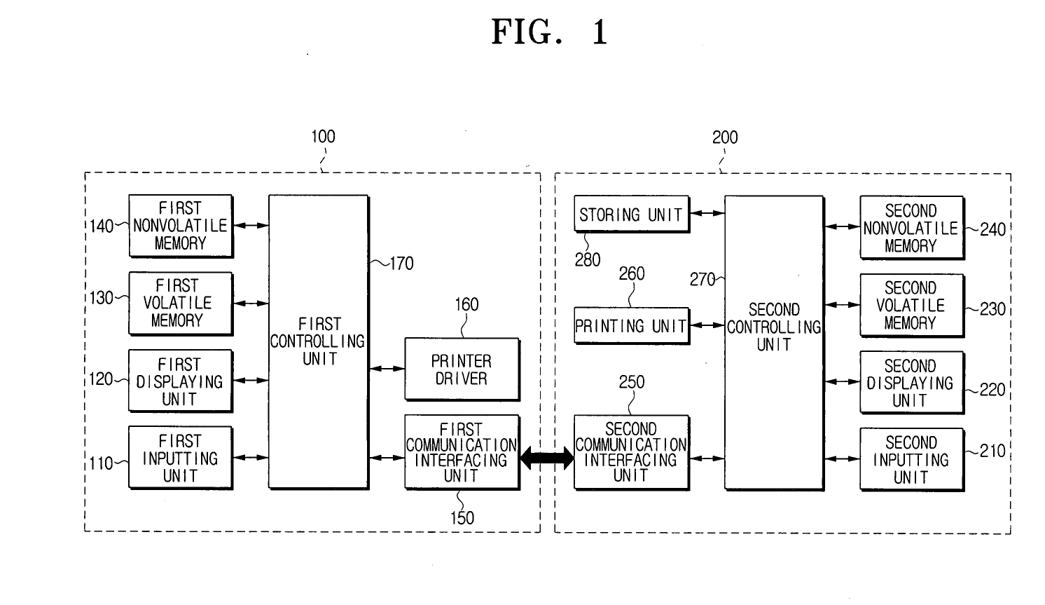

FIG. 1 is a functional block diagram illustrating a structure of a printing system including a host and a printer according to an exemplary embodiment of the present invention. The printing system includes a printer 200 and a host 100. The printer 200 prints a document transmitted from the host 100 and the host 100 controls the printer 200.

The host 100 includes a first inputting unit 110, a first displaying unit 120, a first volatile memory 130, a first nonvolatile memory 140, a first communication interfacing unit 150, a printer driver 160, and a first controlling unit 170. The host 100 may be a PC (personal computer) and a PDA (personal digital assistant) among others.

The first inputting unit 110 is provided with at least one operating button for receiving various user commands. The first inputting unit 110 may be a keyboard or a mouse. The first inputting unit 110 may receive information (referred to as ‘searching information’) needed to search a related document of the printing document (referred to as ‘a related document’). The searching information may be a keyword. The printer 200 searches the related document by using a name, a writer, a writing time, a storing time and a keyword of the printing document. If the printer 200 then transmits the searched related document to the host and displays the transmitted related document on the first displaying unit 120, the first inputting unit 110 may receive at least one of the displayed related documents.

A signal, according to a user command, input through the first inputting unit 110 is provided to the first controlling unit 170, and the first controlling unit 170 controls the host 100 in response to the signal according to the input user command.

The first displaying unit 120 displays various messages informing the user in response to the user command or under the control of the first controlling unit 170. If the printer 200 searches the related document and transmits the searched related document to the host 100, the first displaying unit 120 displays a list of the searched related documents.

The first volatile memory 130 temporarily stores data generated during various operations of the host 100 under the control of the first controlling unit 170.

The first nonvolatile memory 140 stores a program to facilitate overall controlling of the host 100.

The first communication interfacing unit 150 is connected with the second communication interfacing unit 250 of the printer 200 and serves as a channel in a data exchange between the host 100 and the printer 200.

The printer driver 160 converts the document into a language capable of being understood by the printer 200, such as a PDL (printer description language). Together with the document, the searching information and a printing command including various options needed for printing are transmitted to the printer 200 through the first communication interfacing unit 150 under the control of the first controlling unit 170. The printing command and the searching information may be converted into a PJL (printer job language) and transmitted. The searching information may include a name, a writer, a writing time, a storing time and a keyword of the document.

The first controlling unit 170 controls the overall operations of the host according to the program stored in the first nonvolatile memory 140. That is, the first controlling unit 170 controls the host 100 to transmit the document and the searching information to the printer 200, to receive the list of the related documents searched by the printer 200, and to display the list on the first displaying unit 120. The first controlling unit 170 also controls the host 100 to transmit a related document selected by the user in the displayed list to the printer.

The printer 200 includes a second inputting unit 210, a second displaying unit 220, a second volatile memory 230, a second nonvolatile memory 240, a second communication interfacing unit 250, a printing unit 260, a second controlling unit 270 and a storing unit 280.

The second inputting unit 210 has at least one operating button for receiving various user commands, and may be an OPE (operating panel). A signal, according to a user command, input through the second inputting unit 210 is provided to the second controlling unit 270, and the second controlling unit 270 controls the printer 200 in response to the signal according to the input user command.

The second displaying unit 220 displays various messages to inform the user. The messages are displayed in response to the user command or under the control of the second controlling unit 270.

The second volatile memory 230 temporarily stores data generated during operations of the printer 200 under the control of the second controlling unit 270.

The second nonvolatile memory 240 stores a program to facilitate the overall control of the printer 200.

The storing unit 280 stores related documents such as frequently used documents. The storing unit 280 may store a name, a writer, a writing time, a storing time, a keyword and an explanation of the related document. The storing unit 280 may be a memory and HDD (hard disk drive) inside the printer 200, and a memory card connected to the printer 200 such as a flash memory or a USB (universal serial bus) memory.

The second nonvolatile memory 240 which stores the program and the storing unit 280 which stores the related document may be separately implemented, as illustrated in FIG. 1. Alternatively, the second nonvolatile memory 240 and the storing unit 280 may be integrated in the same storing medium.

The second communication interfacing unit 250 serves as a channel for exchanging predetermined data between the host 100 and the printer 200 regardless of whether the second communication interfacing unit 250 is connected to the host via wires or via a wireless connection.

The printing unit 260 prints the document transmitted from the host 100 and the related document stored in the storing unit 280.

The second controlling unit 270 facilitates the overall control of the printer 200 according to a control program stored in the second nonvolatile memory 240. The second controlling unit 270 controls the printer 200 to receive a document and searching information from the host 100, to search the related documents and to transmit a list of the related documents to the host 100. The second controlling unit 270 controls the printer 200 to receive the related document selected by the user from the host 100 and to print the related document together with the document.

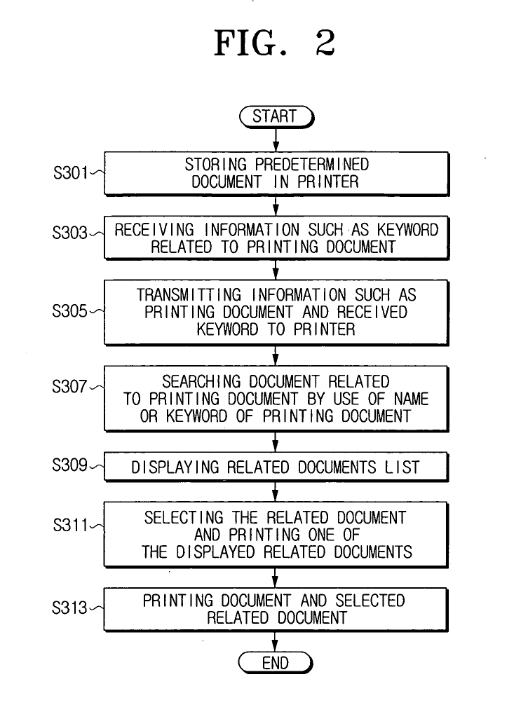

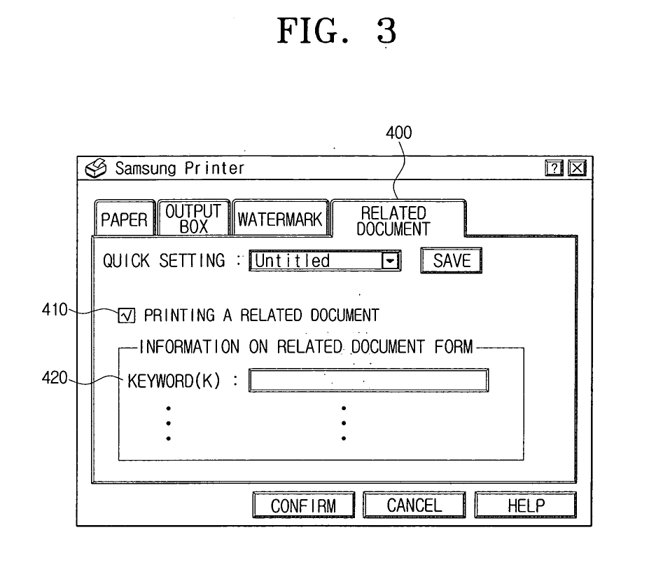

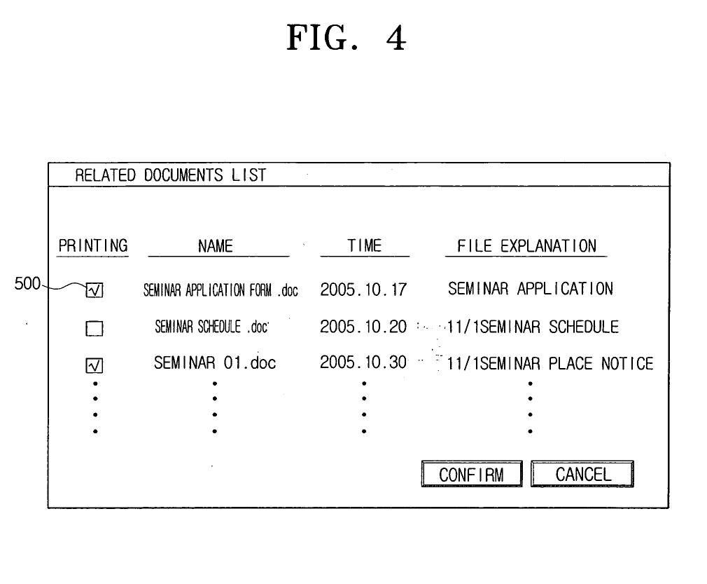

FIG. 2 is a flowchart explaining a method for printing according to the exemplary embodiment of the present invention. FIGS. 3 and 4 illustrate the user interface according to the exemplary embodiment of the present invention. A method for printing a document together with a related document will be described with reference to FIGS. 2-4.

A predetermined document is stored in a printer 200 (S301). The predetermined document is a frequently used document such as an official company document form. The predetermined document may be used as the related document to be printed together with the printing document. The predetermined document may be stored in a storing unit 280 of the printer 200.

Information (hereinafter, referred to ‘index information’) includes a name, a writer, a writing time, a storing time, a keyword and an explanation of the predetermined related document. The index information may be stored together with the predetermined related document. The keyword may be a word that represents the content of the corresponding related document to be stored. The keyword may be used to perform a search to determine whether the corresponding document is related to the printing document. The explanation for the predetermined related document is briefly provided to help the user decide whether the corresponding document is to be printed together with the printing document. The index information may be input through the second inputting unit 210 and stored into the storing unit 280 under the control of the second controlling unit 270. Alternatively, the index information may be input through the first inputting unit 110, transmitted to the printer 200 together with the predetermined document and stored.

The first inputting unit 110 receives searching information for searching the related document (S303). An example of the searching information is the key word. FIG. 3 is an illustration of the user interface provided by the printer driver 160, and includes a tab 400 providing an option of whether to print the printing document and the related document together. In order to print the printing document and the related document together, the user may select an option for ‘printing a related document ’ 410. Furthermore, the searching information may be input for searching the related document. FIG. 3 shows that a keyword 420 is input, as one example. If the keyword 420 is not input, a name of the printing document may be used for searching the related document. Also, a writer, a writing time and a storing time of the related document may be input as the searching information.

The searching information may be input through the printer driver 160 and the UI (user interface) provided by an application.

The first controlling unit 170 transmits the printing document and the searching information to the printer 200 through the first communication interfacing unit 150 (S305). As mentioned above, the searching information may be information needed to search the related document such as a name, a writer, a writing time, a storing time or a keyword of the printing document.

The second controlling unit 270 uses the searching information transmitted from the second communication interfacing unit 250 and the index information of the predetermined related document stored in the storing unit 280 in the step of S301, to search the related document (S307). In one example, a file name of the printing document is ‘seminar 2005.txt’. When the keyword 420 is not input in FIG. 3, a name of the predetermined related document stored as the index information and ‘seminar 2005.txt’ which is a name of the printing document are compared. The name of the predetermined related document and the name of the printing document are compared, so that a search can be performed to determine whether the name of the predetermined document is related to the ‘seminar 2005.txt’. When the keyword is input as ‘seminar’ in FIG. 3, the keyword 420 input as the searching information and the keyword stored as the index information are compared. This comparison is made so that a search can be performed to determine whether the keyword stored as the index information is related to the keyword 420 input as the searching information.

A list of the related documents searched by the printer 200 is displayed (S309). The second controlling unit 270 transmits the list of the related documents searched in the step of S307. The list is transmitted to the host 100 through the second communication interfacing unit 250. The first controlling unit 170 of the host 100 receives the list of the related documents through the first communication interfacing unit 150 and displays the received list on the first displaying unit 120. FIG. 4 is one example of the displayed received list. Alternatively, the list of the related documents may be displayed on the second displaying unit 220.

The first inputting unit 110 is selected with the printing document together with printing one of the displayed related documents (S311). Referring to a file explanation of FIG. 4, the user may decide to print one of the displayed related documents, and to display whether to print each of the related documents (500). Alternatively, when the list of the searched related documents is displayed on the second displaying unit 220 of the printer 200, the second inputting unit 210 may be selected with the printing document together with printing one of the displayed related documents.

The first controlling unit 170 transmits the related document selected in the step of S311 to the printer 200 through the first communication interfacing unit 150, and the printing unit 260 of the printer 200 prints the selected related document together with the printing document under the control of the second controlling unit 270 (S313).

The method mentioned above for printing a document with a related document may be implemented through the program of the printer driver 160 under the control of the controlling unit 170 in the host 100. The program of the printer driver 160 may be stored in the first nonvolatile memory 140. The method for printing a document with a related document may be implemented through the program stored in the second nonvolatile memory 240 under the control of the second controlling unit 270 in the printer 200.

According to the exemplary embodiment of the present invention as mentioned above, frequently used documents which are related documents are stored in the printer, related documents of a printing document are searched from the document forms in the printer and displayed, and at least one of the displayed related document is selected and printed with the printing document, to provide more convenience for the user.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for printing a document with a related document, comprising:
transmitting the document and searching information on the document to a printer;
searching for a related document of the document among at least one document stored in the printer, using the transmitted searching information; and
printing the document together with the related document.

2. The method for printing of claim 1, wherein the document stored in the printer is stored together with index information comprising at least one of a name, a writer, a writing time, a storing time and a keyword of the document stored in the printer, and an explanation on the document stored in the printer, and
the operation of searching compares the searching information and the index information.

3. The method for printing of claim 1, wherein the searching information is at least one of the name, the writer, the writing time, the storing time and the keyword of the document.

4. The method for printing of claim 1, wherein the operation of transmitting comprises the searching information in a PJL (printer job language).

5. The method for printing of claim 1, wherein the operation of transmitting is input with the searching information through a UI (user interface) provided by at least one of a printer driver and an application.

6. The method for printing of claim 1, further comprising:
displaying a list of the searched related document; and
selecting at least one in the list of the displayed related document.

7. The method for printing of claim 6, wherein the operation of displaying is performed by at least one of the printer and a host controlling the printer, and
the operation of being selected is performed by at least one of the printer and the host controlling the printer.

8. A printer receiving a document and searching information on the document, and performing a printing work, the printer comprising:
a storing unit for storing a document;
a printing unit for performing the printing work; and
a controlling unit for controlling a related document of the document to be searched among stored documents by using the searching information, and the document and the related document to be printed by the printing unit.

9. The printer of claim 8, wherein the searching information comprises at least one of a name, a writer, a writing time, a storing time and a keyword of the document.

10. The printer of claim 8, wherein the storing unit stores an index information comprising at least one of the name, the writer, the writing time, the storing time and the keyword of the stored document and an explanation on the stored document, and the controlling unit compares the searching information and the index information, and searches the related document.

11. The printer of claim 8, further comprising:
a displaying unit for displaying a list of the searched related document; and
an inputting unit for selecting at least one related document in the list of displayed related document,
wherein the controlling unit controls the printing unit to print the document and the selected related document.

12. The printer of claim 8, wherein the controlling unit controls the list of the searched related document to be transmitted to the host, at least one related document selected from the list of the related document by a user to be received by the host, and the selected related document and the document to be printed by the printing unit.

13. A host, comprising:
a displaying unit for displaying a list of a related document of a document;
an inputting unit for selecting at least one related document in the displayed list of the related document; and
a controlling unit for controlling the document and searching information on the document to be transmitted to a printer, the list of the searched related document to be received by the printer and displayed by the displaying unit, and the selected related document to be transmitted to the printer.

14. The printer of claim 13, wherein the searching information comprises at least one of a name, a writer, a writing time, a storing time and a keyword of the document.

15. The printer of claim 13, wherein a PJL (printer job language) comprises the searching information and transmits the searching information.

16. The printer of claim 13, wherein the inputting unit is input with the searching information.

17. The printer of claim 13, wherein the inputting unit is a UI (user interface) provided with at least one of a printer driver and an application.

18. The host of claim 13, further comprising a first volatile memory for temporary storage of data generated during various operations of a host under the control of a first controlling unit.

19. The host of claim 13, further comprising a first nonvolatile memory for storing a program to facilitate overall controlling of a host.

20. The host of claim 13, further comprising a first communication interfacing unit connected with a second communication interfacing unit of the printer; wherein the first communication interfacing unit serves as a channel in a data exchange between a host and the printer.

21. The printer of claim 17, wherein the printer driver converts a document into a language capable of being understood by the printer.

22. The printer of claim 8, further comprising a second inputting unit for receiving user commands.

23. The printer of claim 8, further comprising a second displaying unit for displaying messages in response to a user command or under the control of a second controlling unit.
